(19) United States
(12) Patent Application Publication
(10) Pub. No.: US 2026/0295595 A1
(43) Pub. Date: Oct. 1, 2026

(54) SPECIMEN HOLDER

(71) Applicant: Arizona Board of Regents on behalf of Arizona State University, Scottsdale, AZ (US)

(72) Inventors: Barbara Smith, Tempe, AZ (US); Ethan Marschall, Mesa, AZ (US)

(21) Appl. No.: 19/476,498

(22) PCT Filed: May 2, 2024
(86) PCT No.: PCT/US2024/027438

§ 371 Date: Oct. 17, 2025

Related U.S. Application Data
(60) Provisional application No. 63/499,563, filed on May 2, 2023.

(51) Int. Cl. B01L 9/00

(52) U.S. Cl. CPC B01L 9/523; B01L 2200/025; B01L 2200/026; B01L 2300/0809

(57) ABSTRACT

In some aspects, the present invention relates to a specimen holder including a base having a lower surface and a plurality of walls extending upward from the lower surface, defining a cavity, a tray support platform connected to the plurality of walls and arranged parallel to the lower surface of the base, a liquid tray having a bottom and a plurality of walls extending upwards from the bottom, forming a cavity in the liquid tray, a specimen tray having a frame with a bottom portion and a top portion and one or more openings passing through the specimen tray, the specimen tray is configured to reside within the liquid tray, and the liquid tray is placed on the tray support platform of the base.

### CROSS-REFERENCE TO RELATED APPLICATIONS

This application claims the benefit and priority to International Application No. PCT/US2024/027438 filed on May 2, 2024 and U.S. Provisional Application No. 63/499,563 filed on May 2, 2023, the disclosures of which are hereby incorporated by reference in their entirety.

### STATEMENT REGARDING FEDERALLY SPONSORED RESEARCH OR DEVELOPMENT

This invention was made with government support under 1944846 awarded by the National Science Foundation. The government has certain rights in the invention.

### BACKGROUND OF THE INVENTION

Specimen holders have been used in various fields to house biological specimens, for example during experiments. One example of a specimen holder is a brain slice holder, configured to hold brain slices during, for example, electrophysiology. Current brain slice holders are designed to pre-incubate brain slices in separate wells prior to transfer into recording chambers for carbogenation. Current brain slice holders lack the ability to enable carbogenation of brain slices in the same pre-incubated holders. Allowing incubation and carbogenation of brain slices in the same holder ensures stable pH buffering, adequate oxygenation of the slices during experimentation, and does not disturb the brain slices. Lastly, current brain slice holders are costly, only suited for a small number of samples, and are incompatible with common water-bath heaters. Thus, there is a need in the art for a specimen holder, for example a brain slice incubator, that allows for carbogenation during incubation within the device, and offers a configurable and low-cost solution for experimentation. The present invention satisfies that need.

### SUMMARY OF THE INVENTION

In some aspects, the present invention relates to a specimen holder including a base having a lower surface and a plurality of walls extending upward from the lower surface, defining a cavity, a tray support platform connected to the plurality of walls and arranged parallel to the lower surface of the base, a liquid tray having a bottom and a plurality of walls extending upwards from the bottom, forming a cavity in the liquid tray, a specimen tray having a frame with a bottom portion and a top portion and one or more openings passing through the specimen tray, the specimen tray is configured to reside within the liquid tray, and the liquid tray is placed on the tray support platform of the base.

In some embodiments, the specimen holder further includes a layer of material disposed between the bottom and top portion of the specimen tray and forming one or more sample wells in the openings of the specimen tray. In some embodiments, the layer of material is at least one of a mesh material, a porous material, a permeable material, a grid material, a metal material, a plastic material, or a nylon material.

In some embodiments, the base further includes one or more openings in the plurality of walls of the base configured to allow fluid to pass through from the exterior of the base into the cavity of the base. In some embodiments, the base further includes one or more holes in the lower surface of the base configured to allow fluid to pass through from the exterior of the base into the cavity of the base. In some embodiments, the base further includes one or more legs extending downward from the base.

In some embodiments, the specimen holder further includes at least one weight positioned within the cavity of the base. In some embodiments, the openings in the specimen tray comprise a shared opening with one or more tubes positioned in the shared opening. In some embodiments, the specimen holder further includes an air stone positioned in the cavity of the liquid tray and fluidly connected to the one or more tubes. In some embodiments, the shared opening is positioned centrally in the specimen tray, and extends upward a height from the tray.

In some embodiments, the base has a peripheral ridge extending upwards from the tray support platform. In some embodiments, the specimen holder the base includes one or more corner posts extending upwards from at least one corner of the tray support platform. In some embodiments, the specimen holder further includes one or more legs extending downward from the bottom portion of the frame. In some embodiments, the specimen tray includes one or more clips to mechanically and removably affix the top portion onto the bottom portion.

In some embodiments, the specimen holder includes at least one material selected from the group consisting of: PLA, PEEK, ABS, PET, PVA, PTFE, PETG, polycarbonate, polypropylene, polyethylene, polyamide, polyvinyl chloride, glass-fiber polypropylene (GFPP), and nylon. In some embodiments, the base has a length ranging between 5 cm and 20 cm, a width ranging between 5 cm and 20 cm, and a height ranging between 5 cm and 15 cm. In some embodiments, the specimen tray has a length ranging between 5 cm and 15 cm, a width ranging between 5 cm and 15 cm, and a height ranging between 1 cm and 10 cm. In some embodiments, the liquid tray has a length ranging between 5 cm and 15 cm, a width ranging between 5 cm and 15 cm, and a height ranging between 1 cm and 10 cm. In some embodiments, the specimen holder the base is a shape selected from the group consisting of: a triangle, a square, a rectangle, a trapezoid, a pentagon, a hexagon, an octagon, a decagon, a circle.

In some embodiments, the specimen holder is positioned in a water bath and the water of the bath does not intrude into the cavity of the liquid tray.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1A is a perspective view of an exemplary specimen holder according to aspects of the present invention.

FIG. 1B is a side cutaway view of the specimen holder of FIG. 1A.

FIG. 1C is a rear view of the specimen holder of FIG. 1A.

FIG. 2A is a perspective view of an exemplary base for a specimen holder.

FIG. 2B is a top down view of the base of FIG. 2A.

FIG. 2C is a side cutaway view of the base of FIG. 2A wherein dashed lines represent hidden features or elements of the base.

FIG. 2D is a side view of the base of FIG. 2A.

FIG. 3A is a perspective view of an exemplary specimen tray comprising a top and bottom portion according to aspects of the present invention.

FIG. 3B is a perspective view of an exemplary specimen tray bottom portion according to aspects of the present invention.

FIG. 3C is a top down view of the specimen tray bottom portion of FIG. 3B.

FIG. 3D is a side view of the specimen tray bottom portion of FIG. 3B wherein dashed lines represent hidden features or elements of the bottom portion.

FIG. 3E is a side view of the specimen tray bottom portion of FIG. 3B.

FIG. 4A is a perspective view of an exemplary specimen tray top portion to aspects of the present invention.

FIG. 4B is a top down view of the specimen tray top portion of FIG. 4A.

FIG. 4C is a rear view of the specimen tray top portion of FIG. 4A.

FIG. 4D is a side view of the specimen tray top portion of FIG. 4A.

FIG. 5A is a perspective view of an exemplary specimen tray top portion according to aspects of the present invention.

FIG. 5B is a bottom view of the specimen tray top portion of FIG. 5A.

FIG. 6 is an enlarged view of an exemplary specimen tray comprising a top and bottom portion wherein the top portion and bottom portion fit or interlock together.

FIG. 7 is a perspective view of an exemplary specimen tray comprising a top portion, a bottom portion, and a layer of nylon mesh material positioned between the top portion and the bottom portion,

FIG. 8 is a perspective view of an exemplary specimen tray comprising a top portion, a bottom portion, and a layer of nylon mesh material positioned between the top portion and the bottom portion.

FIG. 9 is a top down view of the components of an exemplary specimen holder comprising a base with a weight, a liquid tray, and a specimen tray.

FIG. 10 is a perspective view of the components of an exemplary specimen holder comprising a base with a weight, and a liquid tray placed on the base, wherein the liquid tray is positioned on the base.

FIG. 11 is a perspective view of an exemplary specimen holder comprising a base, a liquid tray, and a specimen tray, wherein the liquid tray is placed on the base, and the specimen tray is placed at least partially into the liquid tray.

FIG. 12 is a perspective view of an exemplary specimen holder placed in a water bath and connected to a fluid source according to aspects of the present invention. In some embodiments, the specimen holder is configured to maintain the temperature of samples, and provide a flow of fluid to the samples (e.g. carbogenation of brain slices placed in the wells of the specimen tray).

### DETAILED DESCRIPTION OF THE INVENTION

It is to be understood that the figures and descriptions of the present invention have been simplified to illustrate elements that are relevant for a clearer comprehension of the present invention, while eliminating, for the purpose of clarity, many other elements found in related devices, systems and methods (e.g., sample holders, carbogenation systems, electrophysiology systems, brain slice holders and systems). Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

As used herein, each of the following terms has the meaning associated with it in this section.

The term “fluid” is used herein to refer to any substance that has no fixed shape and yields easily to external pressure, such as a gas or a liquid. Non-limiting examples of fluids include: gas, liquid, gas mixtures, liquid mixtures, water, blood, blood, serum, body fluids, and any combination thereof.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

Ranges: throughout this disclosure, various aspects of the invention can be presented in a range format. It should be understood that the description in range format is merely for convenience and brevity and should not be construed as an inflexible limitation on the scope of the invention. Where appropriate, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Disclosed herein is a novel specimen holder used in some examples for incubating tissue samples during electrophysiology experimentation. The disclosed holder includes a sample and liquid tray configured to hold one or more samples (e.g., tissue samples, brain slices, or the like). The holder provides a novel means of providing a flow of fluid (e.g., carbogenation) to the samples with an air stone while also providing a means for temperature control. In some embodiments, the holder is partially immersed in a water bath for temperature control.

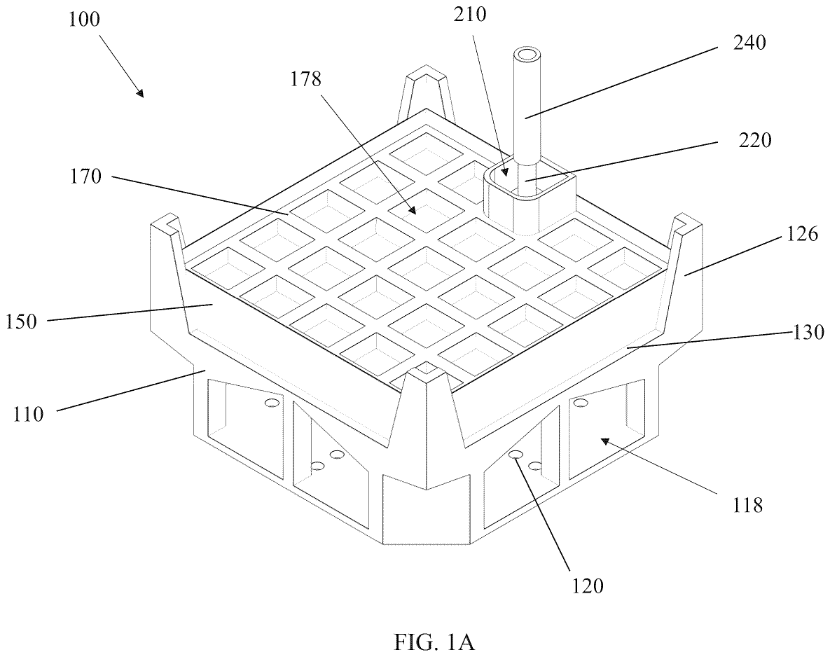

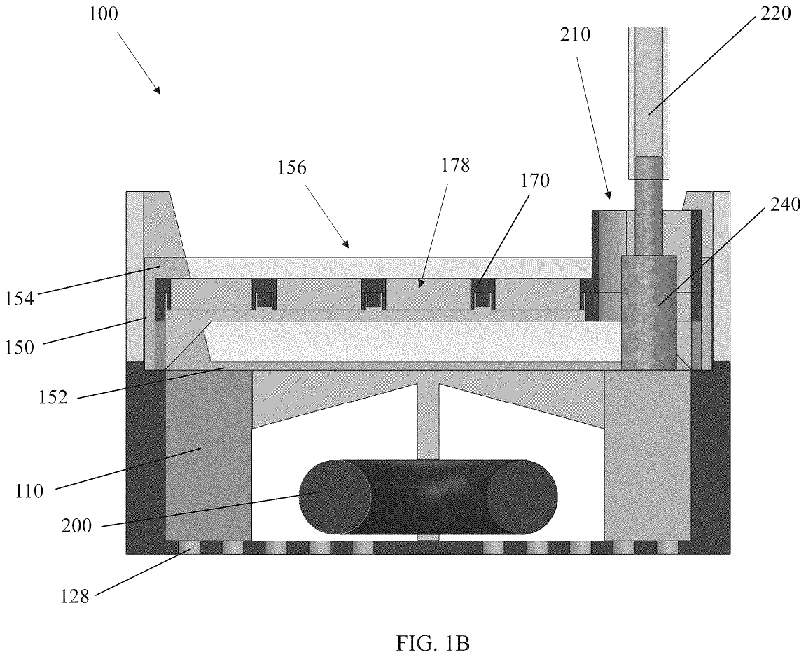

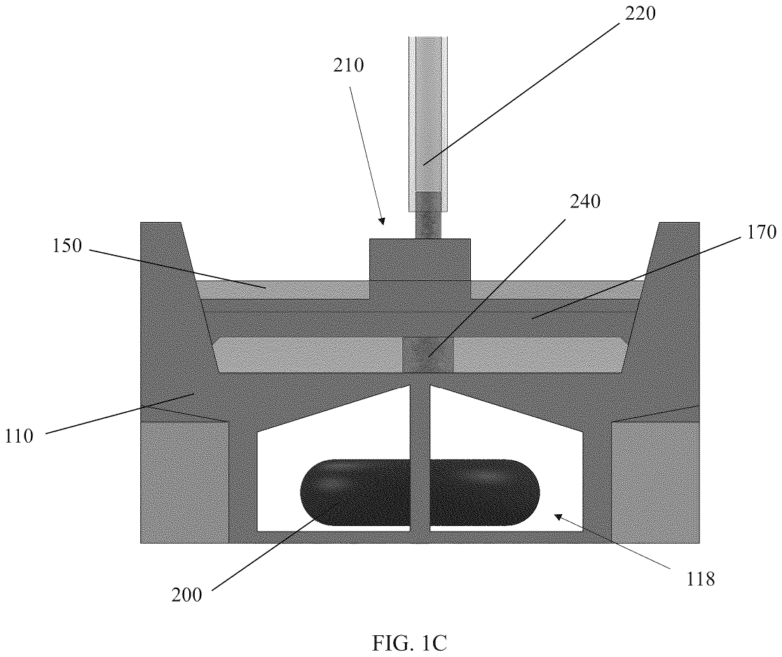

Referring now to FIGS. 1A-1C, shown are various views of an exemplary specimen holder 100 according to aspects of the present invention. Specimen holder 100 comprises a base 110, a liquid tray 150, and a specimen tray 170 configured to hold one or more samples. Base 100 comprises a tray support platform 130 to securely hold liquid tray 150 and specimen tray 170 in a fixed position. In some embodiments, specimen holder 100 is configured to be partially submerged in a temperature-controlled fluid or liquid bath (e.g., a water bath). For example, in some embodiments, base 110 positions liquid tray 150 partially in a liquid bath (see FIG. 12 for an example of liquid tray 150 partially submerged in a water bath 400). Liquid tray 150 securely holds specimen tray 170 and comprises at least one air stone 240 to provide a flow of fluid to the samples (e.g., provide carbogenation to brain slices). In some embodiments, air stone 240 is positioned within the cavity of liquid tray 150 and is fluidly connected to one or more fluid sources. It should be appreciated that specimen holder 100 may comprise any known tubes, conduits, connectors, manifolds, pumps, fluid sources, controllers, or combinations thereof in order to provide a desired flow of fluid to the samples.

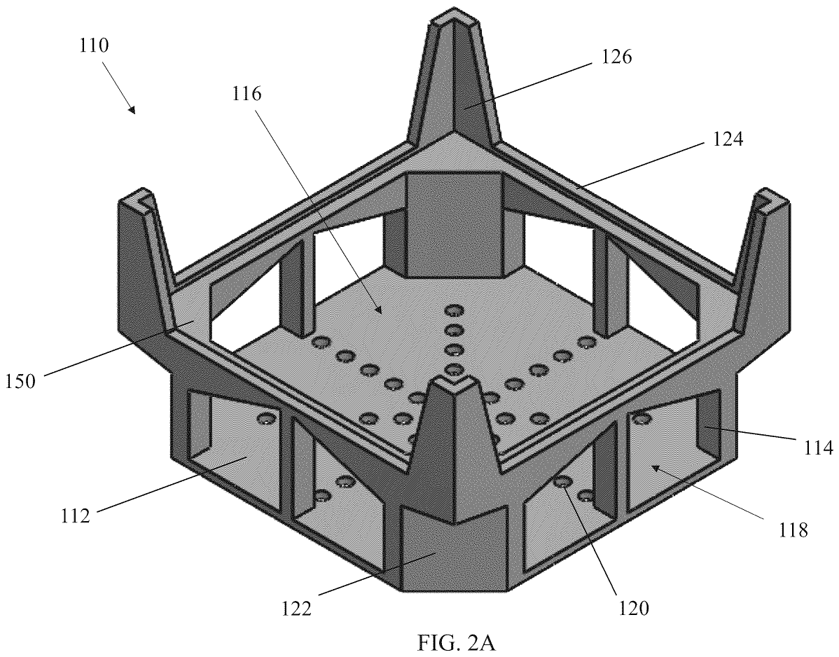

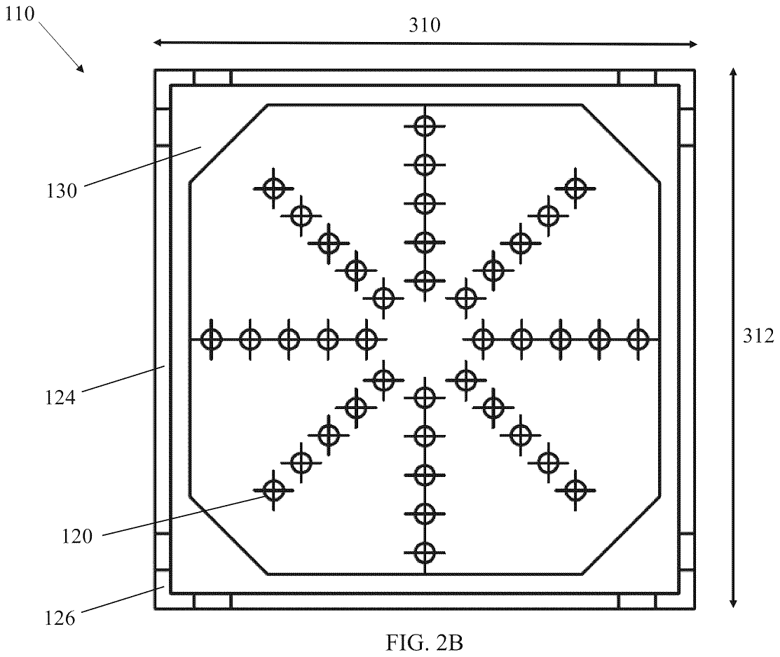

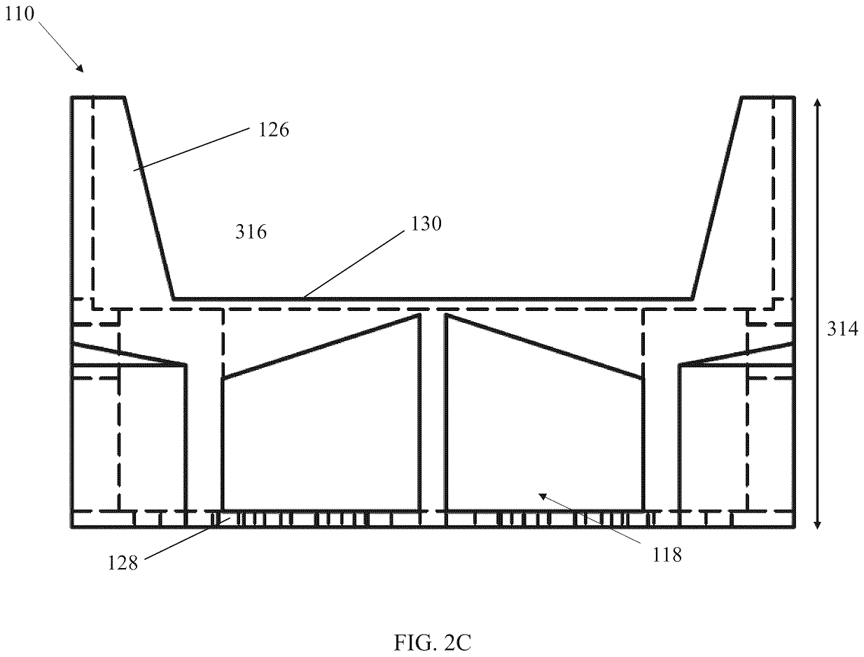

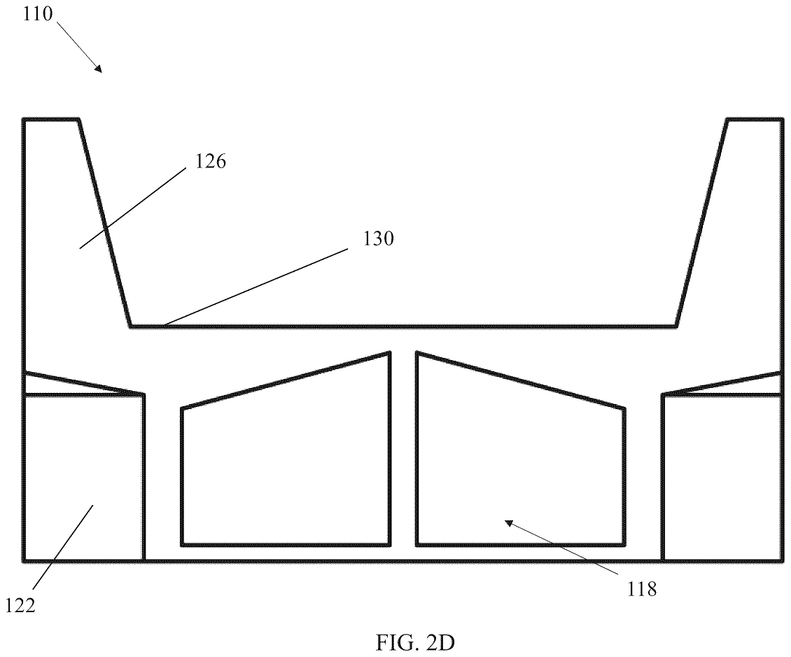

Aspects of the present invention relate to a base for specimen holder 100 configured to hold the liquid tray 150 (and specimen tray 170). Referring now to FIG. 2A, shown is an exemplary base 110 comprising a lower surface 112 and a plurality of walls 114 extending upward from lower surface 112 defining a cavity 116. Base 110 comprises a tray support platform 130 formed on or attached to the base. In some embodiments, tray support platform 130 is connected or attached to the plurality of walls 114, and is arranged parallel to lower surface 112. In some embodiments, tray support platform 130 is sized and shaped to fixedly and releasably hold liquid tray 150.

In some embodiments, base 110 comprises openings 118 in sidewalls 114, and one or more holes 120 in lower surface 112, which may, for example, serve to allow fluid (e.g., water) to flow into the cavity 116 when base 110 is partially immersed in a water bath. The one or more openings 118 may be suitably sized or shaped to allow sufficient flow in and out of cavity 116. For example, in some embodiments, one or more openings 118 are trapezoidal shape, or square, circular, oblong, round, or oval. The one or more hole 120 of base 110 may be any suitable size and shape and arranged in any suitable pattern in lower surface 112, for example a circular pattern, a square pattern, an X pattern, a star pattern, a starburst pattern, a grid pattern, a random pattern, or any combination thereof. Although examples are provided herein where specimen holder 100 is partially submerged in a fluid (e.g., a water bath), it should be appreciated that the specimen holder 100 may further comprise or utilize any temperature control, heating and/or cooling means known by one of ordinary level of skill in the art.

In some embodiments, base 110 comprises one or more legs, feet or protrusions to raise the base away from a surface, such as the bottom surface of a water bath (e.g., water bath 400), allowing fluid to pass underneath base 110. For example, in some embodiments, base 110 further comprises one or more legs 128 extending downer from the base(see FIG. 1B). In some embodiments, one or more legs 128 comprises 2 legs, or 4 legs, 6 legs, 8 legs, 10 legs, 12 legs, 14 legs, 16 legs or any number of legs extending downward from lower surface 112 of base 110. Referring now to FIG. 2B, in some embodiments, base 110 is at least partially formed in a square shape. However, base 110 may be formed in any suitable shape, or combinations of shapes, including but not limited to a triangle, rectangle, trapezoid, pentagon, hexagon, octagon, decagon, circle, or the shape of any specimen tray known in the art. In some embodiments, base 110 may have an elongated rectangular shape and may be configured to receive two or more specimen trays positioned next to one another. In some embodiments, base 110 is shaped to enable a lateral and/or uniform flow of fluid from one side of the base to another.

In some embodiments, one or more weighted objects may be formed with, or positioned within specimen holder 100 (e.g., in cavity 116 of base 110, or cavity 156 of liquid tray 150). In some embodiments, one or more weight 200 is positioned within cavity 116 of base 110 to weigh down the base in a liquid bath, or decrease the buoyancy of the base. For example, in some embodiments, a ring-shaped weight 200 is placed in cavity 116 in order to partially submerge specimen holder 100 in a water bath. Weight 200 may be any suitable size, shape and weight in order to at least partially weigh down base 110 and/or liquid tray 150. In some embodiments, specimen holder 100 comprises a weight 200 embedded within base 110 (e.g., in lower surface 112), or forming lower surface 112, or within support platform 130, or any combination thereof.

In some embodiments, base 110 further comprises a rim or ridge at least partially surrounding and extending up from tray support platform 130 and configured to hold or retain specimen tray 170 in a fixed position with respect to base 110. Referring now to FIG. 2A, shown is an exemplary peripheral ridge 124 extending upwards from tray support platform 130 and connected to the one or more corner posts 126. In some embodiments, peripheral rim 124 and/or corner posts 126 may guide the specimen tray into a fixed position on tray support platform 130, or may allow for the positioning of other devices or structures on or attached to base 110. In some embodiments, peripheral ridge 124 may be keyed, for example including a notch or protrusion positioned respective to a corresponding notch or protrusion in a specimen tray (e.g., specimen tray 170), configured to align or guide the specimen tray to be positioned in the same orientation on tray support platform 130 each time.

In some embodiments, base 110 comprises one or more bevels, keys, or alignment features. The corners of base 110 may comprise one or more beveled corners 122, which may serve for example as structural reinforcement or may in some embodiments enable easier positioning of the base into a lower structure having corresponding beveled corners or features. In some embodiments, base 110 may be keyed, i.e. the base may have one or more non-beveled corners arranged in a pattern so as to ensure that it is placed in a consistent orientation within a water bath or other lower structure configured to receive the base. In some embodiments, base 110, the lower surface 112 of base 110, or the legs of base 110, may comprise a high friction material, a high friction layer, an adhesive material, an adhesive layer, an adhesive coating, a rubber material, a magnetic layer, rubber layer, one or more rubber pucks or friction pucks, one or more rubber discs, or any combination thereof. For example, in some embodiments, the legs of base 110 comprise a rubber bottom for creating a high friction footing to prevent movement of base 110 while submerged in a water bath.

Aspects of the present invention relate to a liquid tray for specimen holder 100.

Liquid tray 150 may be at least partially filled with at least one fluid, and is configured to allow the fluid to at least partially contact specimen tray 170. Further, as discussed herein, the liquid tray 150 is configured to isolate specimen tray 170 (and any loaded samples) in isolation from cavity 116 of base 110 and water bath 400. Referring now to FIG. 1B, shown is a side cutaway view of specimen holder 100 comprising a liquid tray 150. In some embodiments, liquid tray 150 comprises a bottom 152 and a plurality of walls 154 extending upwards from bottom 152 forming a cavity 156 in the tray. Liquid tray 150 is appropriately sized and shaped to fixedly hold or retain a specimen tray (e.g., specimen tray 170).

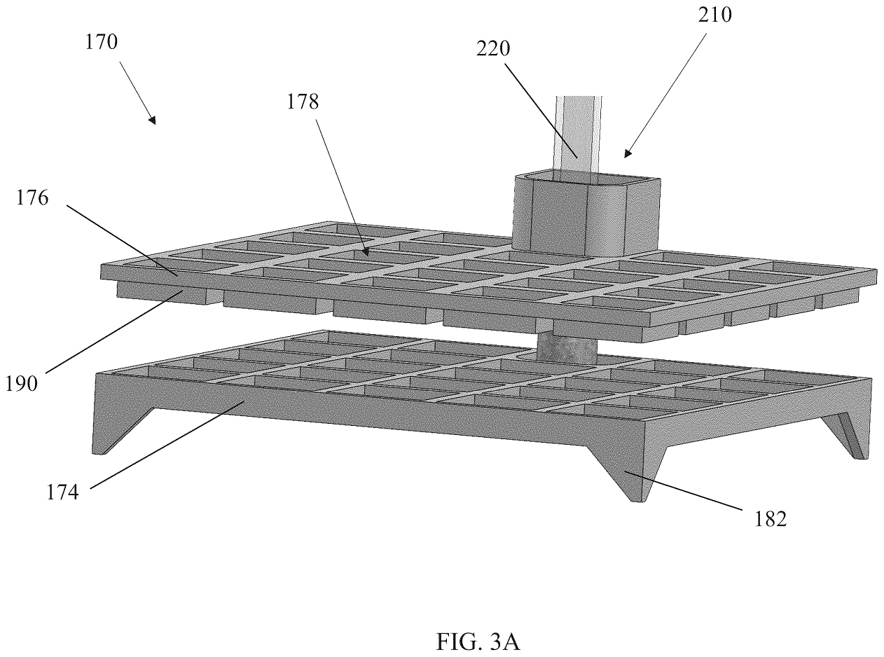

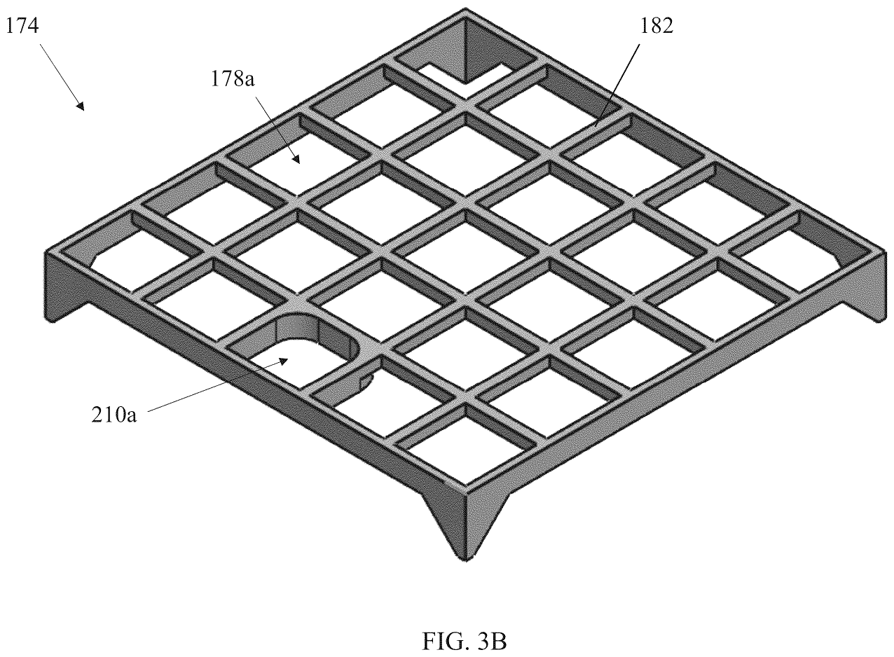

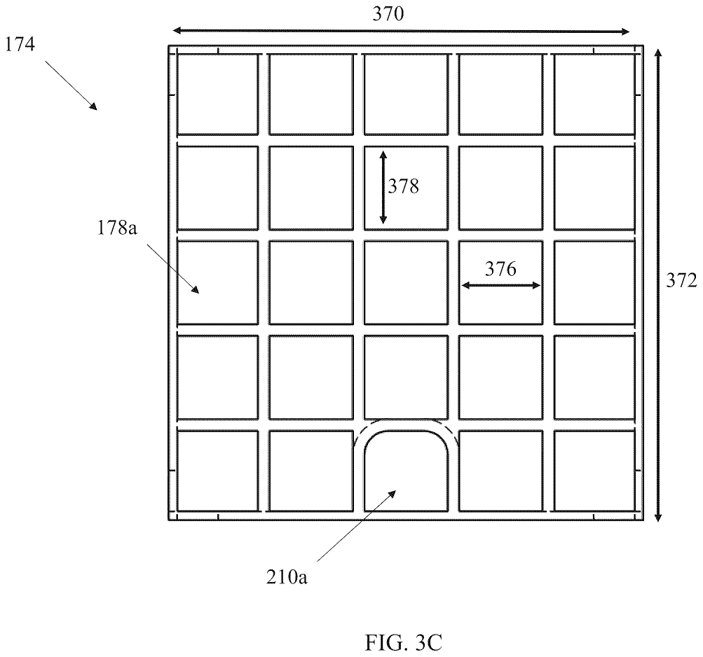

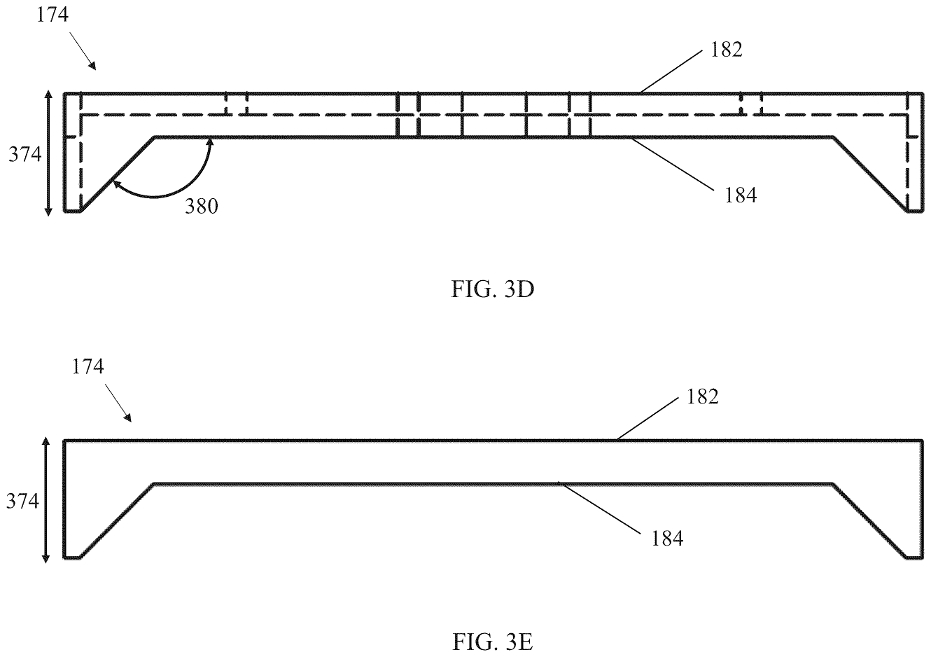

Aspects of the present invention relate to a specimen tray for a specimen holder 100. It should be appreciated that the specimen tray comprises opening forming wells where one or more samples (e.g., brain slices) may be positioned. Referring now to FIG. 3A, shown is an exemplary specimen tray 170 according to aspects of the present invention. In some embodiments, specimen tray 170 comprises a frame with a bottom portion 174 and a top portion 176, and one or more openings 178 passing through the specimen tray 170. In some embodiments, openings 178 in specimen tray 170 comprise a shared opening 210, that passes through both the bottom portion 174 and top portion 176, with one or more tubes 220 positioned at least partially in shared opening 210, or passing through shared opening 210, or connecting to an air stone 240 at least partially positioned in the opening. In some embodiments, shared opening 210 is configured to retain a fluid source, tubing, one or more air stones, diffusion stones, diffusers, or the like, or any combination thereof. Specimen tray 170 is appropriately sized and shaped to reside at least partially within liquid tray 150. In some embodiments, specimen tray 170 further comprises one or more legs 182 extending downward from the bottom portion 174 of frame 172 configured to sit atop tray support platform 130. One or more legs 182 may be suitably sized and shaped to fit on tray support platform 130, and raise or space the specimen tray 170 away from tray support platform 130.

Referring now to FIG. 3A, the one or more openings 178 of specimen tray 170 are formed from one or more openings 178a in bottom portion 174 that align with one or more openings 178b in top portion 176. Further, the shared opening 210 in specimen tray 170 is formed from shared opening 210a in bottom portion 174 being aligned with shared opening 210b in top portion 176. In some embodiments, one or more openings 178 are arranged in a grid pattern. In another example, one or more openings 178 are arranged in a 3×3 grid, a 4×4 grid, 5×5 grid, a 6×6 grid, a 4×5 grid, a 5×6 grid, or any other pattern. In some embodiments, openings 178 are square, rectangle, circle, oval, or triangle shaped openings. In some embodiments, shared opening 210 is configured to align with at least a portion of base 110. In some embodiments shared opening 210 is configured to align the top and bottom portion of specimen tray 160, in order to orient and/or position the bottom portion 174 with the top portion 176. In some embodiments, shared opening 210 comprise a keyed, curved, rounded or chamfered opening. Shared opening 210 can be any suitable size, shape and comprise fitting, threads or connectors in order to facilitate an air stone or diffuser to pass through specimen tray 170, and at least partially reside within the opening.

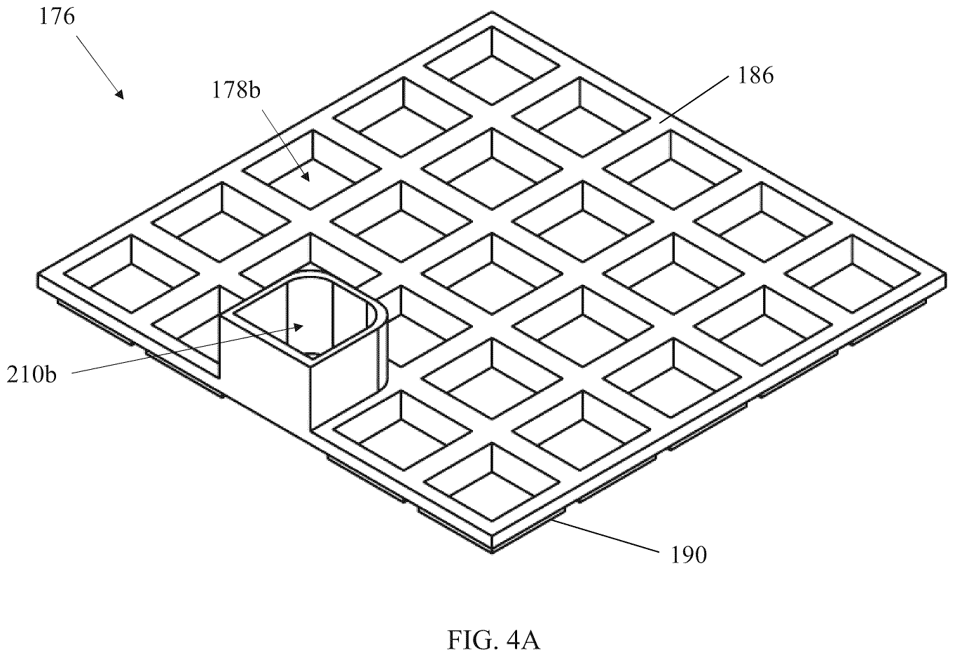

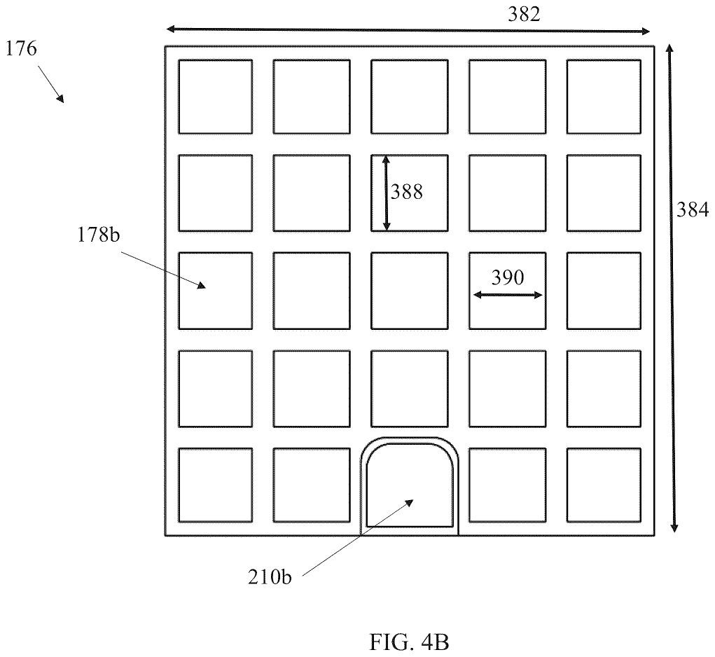

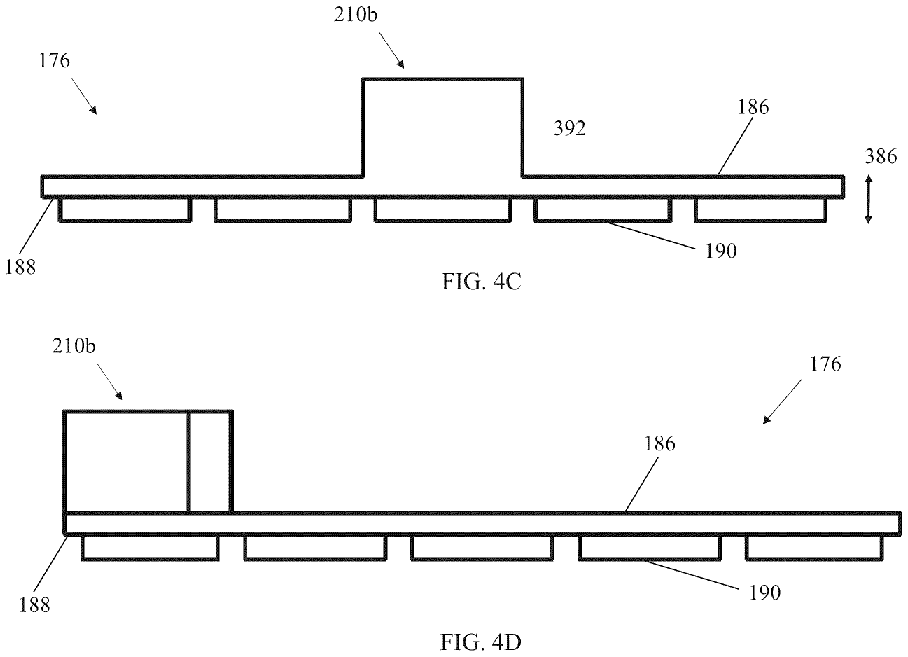

Aspects of the present invention relate to specimen tray 170 comprising interlocking features and features that form a plurality of sample wells. Referring now to FIG. 4A through FIG. 4D, shown is an exemplary top portion 176 for specimen tray 170. In some embodiments, top portion 176 is configured to fit over bottom portion 174, and fixedly and releasably attach to bottom portion 174. In some embodiments, at least a portion of top portion 176 proceeds into bottom portion 174, when specimen tray 170 is assembled. This interlocking aspect of top portion 175 and bottom portion 176 allows a layer of material to be fixedly and removably positioned between the portions, and forms distinct, separate wells in specimen tray 170. In some embodiments, bottom portion 174 comprises a top surface 182, and a bottom surface 184 (see FIG. 3D), and top portion 176 comprises a top surface 186, and a bottom surface 188. In some embodiments, top portion 176 comprises well extensions 190 comprising walls extending downward from openings 178b and bottom surface 188, wherein at least a portion of well extensions 190 reside in openings 178a of bottom portion 174.

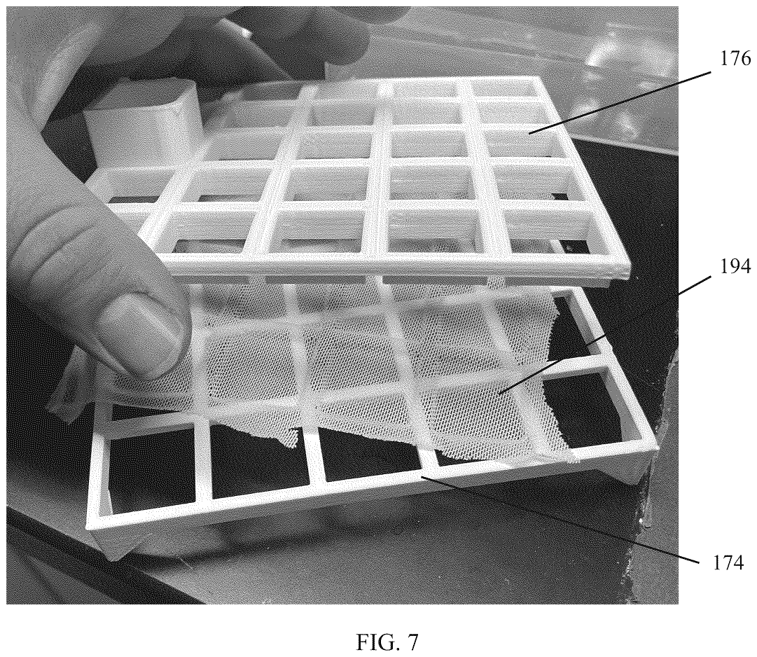

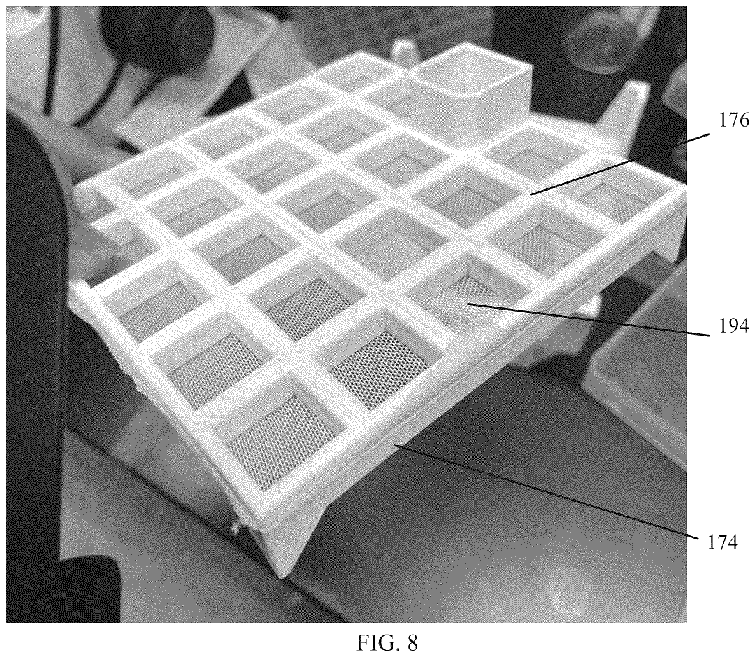

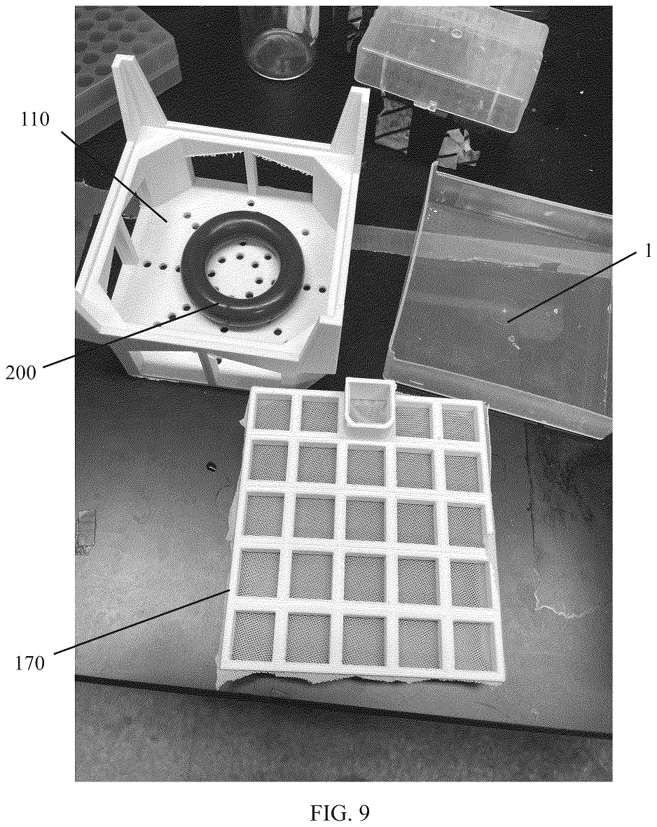

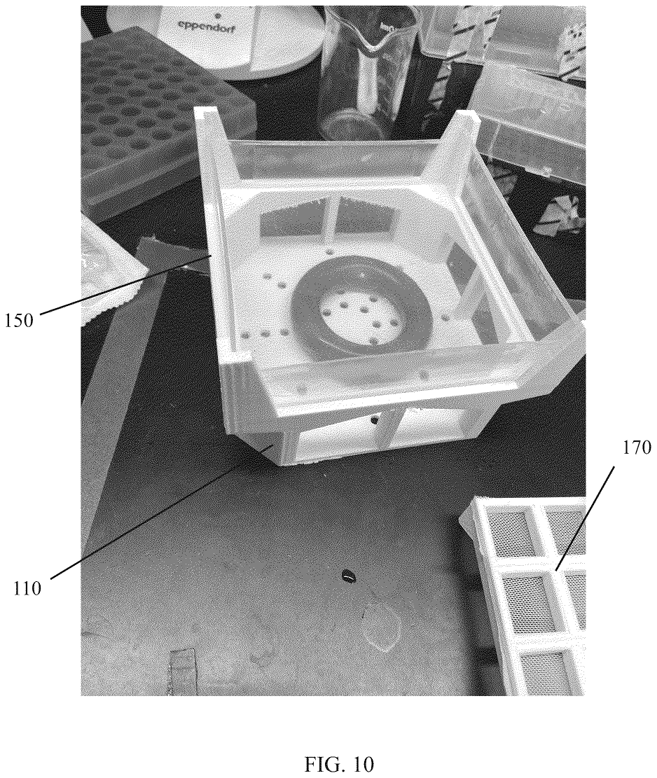

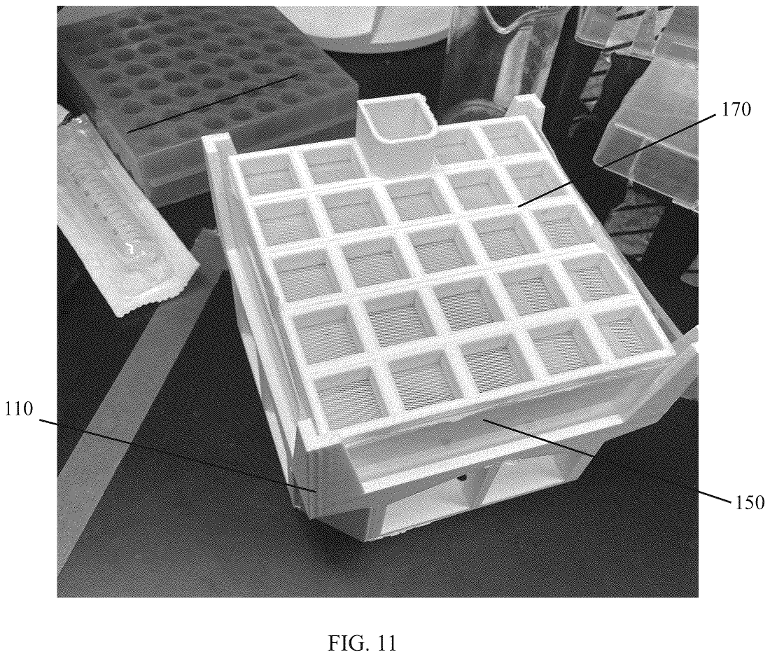

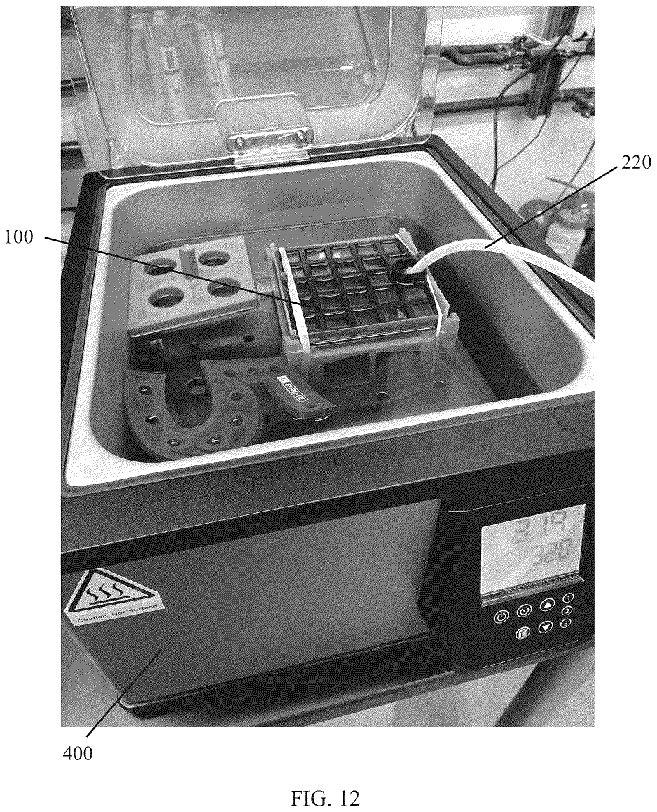

In some embodiments, top portion 176 and bottom portion 174 are configured to fix, retain, sandwich and/or enclose a layer of material. In some embodiments, this layer of material is a porous material, a mesh material, a permeable material, a grid material, or the like. For example, in some embodiments, a layer of material 194 (shown in FIG. 7 and FIG. 8) is disposed or positioned between bottom portion 174 and top portion 176 of specimen tray 170, and at least partially forms one or more sample wells in openings 178 of specimen tray 170. In some embodiments, the material is a layer of nylon mesh. In some embodiments, the material is configured to provide a permeable base for the wells formed in specimen tray 170. In some embodiments, the material allows fluid and at least one fluid to pass through the material, while retaining a sample in the wells formed by openings 178 and permeable material. In some embodiments, layer of material 194 comprises at least one selected from the group consisting of a mesh material, a porous material, a permeable material, a grid material, a metal material, a plastic material, or a nylon material.

As shown in FIG. 1A, the top portion 176 of specimen tray 100 is configured to rest on top of bottom portion 174, and then be positioned within liquid tray 150. In some embodiments, liquid tray 150 may be sized and shaped to be removably positioned on tray support platform 130 of base 110. In some embodiments, liquid tray 150 and/or specimen tray 100 may be formed as a single unit with base 110. In some embodiments, specimen tray 170 forms a matrix or grid of wells, the wells comprising a bottom layer of porous material, wherein samples may be positioned and/or stored within the wells.

In some embodiments, specimen tray 170 may comprise one or more clips or other fasteners to mechanically and removably affix the top portion 176 onto bottom portion 174.

Clips or fasteners as contemplated herein may be positioned on the periphery of the top and bottom portions, or may alternatively or additionally be positioned on the inner part or toward the center of the top and bottom portions. In some embodiments, one or more magnets may be used to hold the top and bottom portions together, either positioned on the outer surfaces of the top and bottom portions or embedded within the top and bottom portions. In some embodiments, no fasteners or clips are used, and the top and bottom portions are configured to friction-or compression-fit into one another so that some amount of attachment force is necessary to attach the top portion 176 to the bottom portion 174, and some amount of removal force is necessary to remove the top portion 176 from the bottom portion 174.

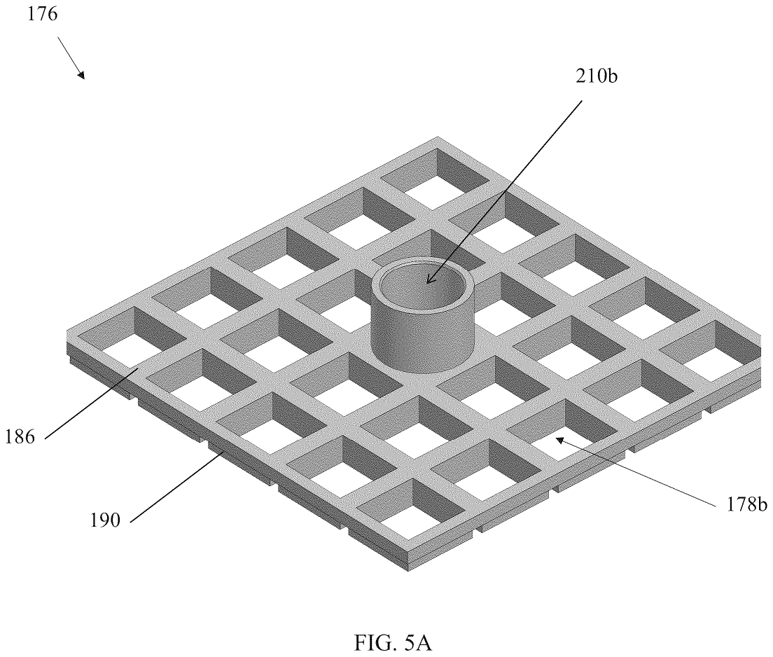

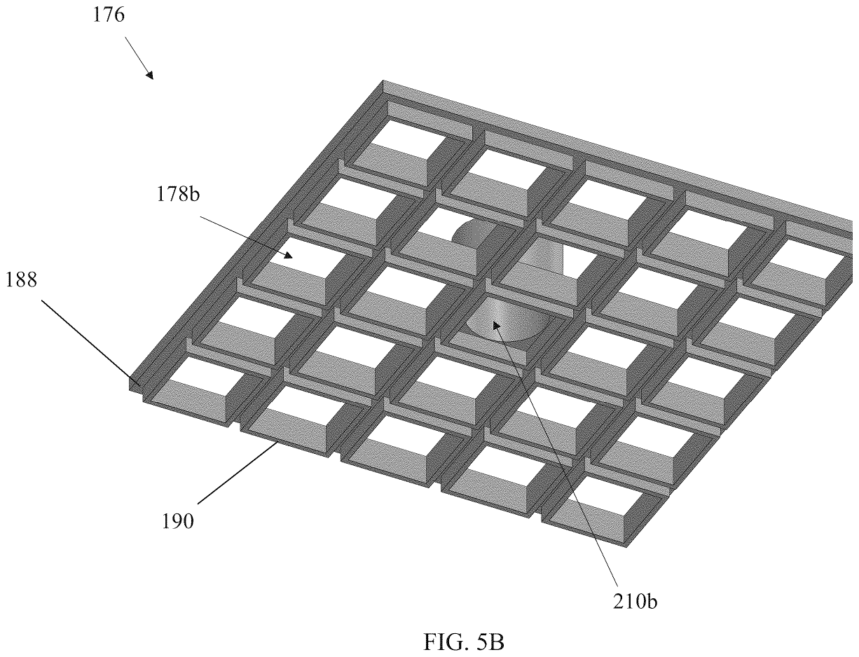

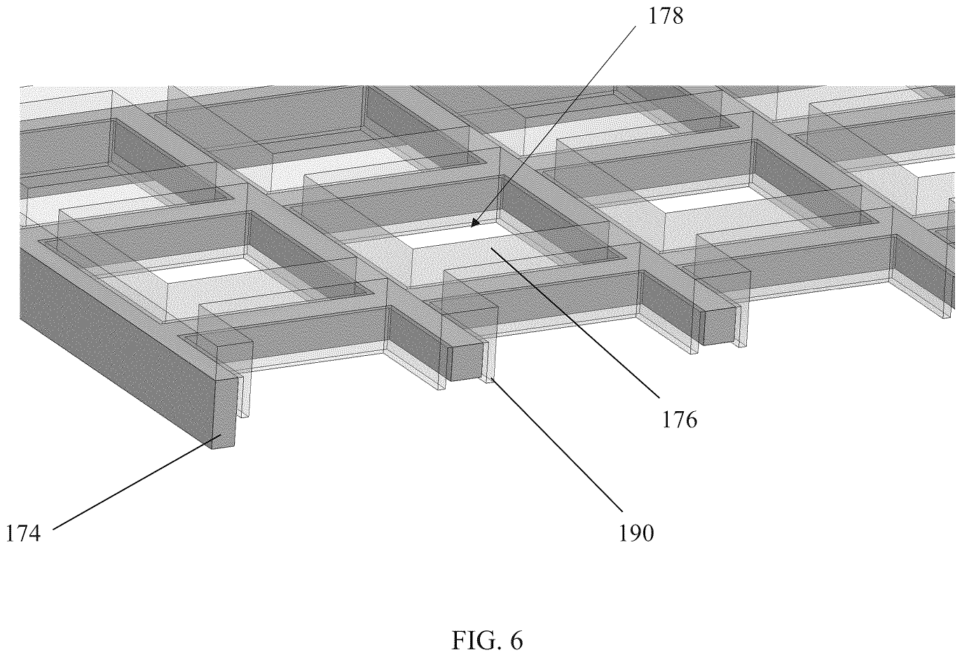

With reference to FIG. 5A and FIG. 5B, shown is an exemplary top portion 176 according to aspects of the present invention. In some embodiments, top portion 176 comprises an alignment channel 210b positioned centrally in top portion 176. Similarly, in some embodiments, bottom portion 174 comprises a centrally located alignment channel (not shown) in order to align with alignment channel 210b. A centrally located alignment channel 210 provides consistent fluid flow (e.g., the carbogenation of artificial spinal fluid) to each of the wells of specimen tray 170. In some embodiments, any portion of device 100 (e.g., openings, conduits, wells, tubes, paths, air stones, air stone 240, diffusers) may comprise one or more fittings, threads, connectors, or the like, that would be known by one of ordinary level of skill in the art. For example, but without limitation, alignment channel 210 may comprise a threaded region (e.g., ½″ NPT threading), such that conduits, connections, and/or tubes may fixedly, sealingly and releasably attach together, in order to resist fluid leaks and/or the device or components being pulled apart or pulled out.

Aspects of the present invention relate to the dimensions of specimen holder 100.

With reference to FIG. 2B and FIG. 2C, base 110 may have any suitable length 310, width 312, or height 314. In some embodiments, the length 310 may be between 10 cm and 15 cm, or about 12 cm, about 13 cm, or about 14 cm. In some embodiments, like the one shown, the width 312 may be equal or about equal to the length 310, or may alternatively be an even multiple of the length 310 (for example to accommodate multiple square specimen trays), for example 2×, 3×, or 4× the length 310. In some embodiments, the width 312 may be greater than or less than the length 310 in order to accommodate a specimen tray that is not square. The base 110 may have a height 314 of between 6 cm and 10 cm, or between 7 cm and 9 cm, or about 8 cm or about 8.1 cm. In some embodiments, base 110 has a length 310 ranging between 5 cm and 20 cm, a width 312 ranging between 5 cm and 20 cm, and a height 314 ranging between 5 cm and 15 cm. Referring now to FIG. 2C, the corner posts 126 may form an angle 316 with respect to the tray support platform 130. The angle 316 may be a right angle or an obtuse angle, for example 95° to 120°, 100° to 100°, about 176°, about 174°, or any other suitable angle.

In some embodiments, specimen tray 170 has an overall length ranging between 5 cm and 15 cm, an overall width ranging between 5 cm and 15 cm, and an overall height ranging between 1 cm and 10 cm. With reference to FIG. 3C, FIG. 3D, and FIG. 3E, bottom portion 174 may have any suitable length 370, width 372 and height 374. In some embodiments, length 370 and/or width 372 may be between 10 cm and 15 cm, or about 12 cm, about 13 cm, or about 14 cm. In some embodiments, height 374 may be between 1 cm and 5 cm, 2 cm and 4 cm, or about 3 cm. In some embodiments, openings 178 have a length 376 and a width 378. In some embodiments, length 376 and/or width 378 may be between 1 cm and 5 cm, 2 cm and 4 cm, or about 3 cm. In some embodiments, shared opening 210 has a length and/or width ranging between 1 cm and 5 cm, 2 cm and 4 cm, or about 3 cm. In some embodiments, the plurality of legs 182 may form an angle 380 with respect to the frame of bottom portion 174. The angle 380 may be a right angle or an obtuse angle, for example 95° to 120°, 100° to 100°, about 176°, about 174°, or any other suitable angle.

With reference to FIG. 4B, FIG. 4C, and FIG. 4D, the top portion 176 of specimen tray 170 may have any suitable length 382, width 384 and height 386. In some embodiments, length 382 and/or width 384 may be between 10 cm and 15 cm, or about 12 cm, about 13 cm, or about 14 cm. In some embodiments, height 386 may be between 1 cm and 5 cm, 2 cm and 4 cm, or about 3 cm. In some embodiments, openings 178b have a length 388 and a width 390. In some embodiments, length 388 and/or width 390 may be between 1 mm and 5 cm, 1 cm and 5 cm, 2 cm and 4 cm, or about 3 cm. In some embodiments, alignment channel 210b has a length, width and/or height ranging between 1 cm and 5 cm, 2 cm and 4 cm, or about 3 cm. In some embodiments, openings 178b and alignment channel 201b have the same length and width. In some embodiments, openings 178b and shared opening 210b have different length and width. In some embodiments, shared opening 210a extends upward a height 392 from top surface 186 of top portion 176, wherein the height is between 1 mm and 10 cm, or about 0.5 cm, or 1 cm, or 2 cm. In some embodiments, extensions 190 extend downward a height from bottom surface 188 ranging between 1 mm and 2 cm, or about 1 mm, or 2 mm, 3 mm, 4 mm, 5 mm, or between 1 mm and 10 mm.

In some embodiments, liquid tray 150 has a length ranging between 5 cm and 15 cm, a width ranging between 5 cm and 15 cm, and a height ranging between 1 cm and 10 cm.

In some embodiments, base 110 is at least partially formed in one or more shapes, where in the one or more shapes are selected from the group consisting of: a triangle, a square, a rectangle, a trapezoid, a pentagon, a hexagon, an octagon, a decagon, a circle.

Any part of disclosed specimen holder 100 may comprise one or more suitable materials as would be known by one of ordinary level of skill in the art. Any portion of specimen holder 100 may be formed of, or comprises at least one material selected from the group consisting of: PLA, PEEK, ABS, PET, PVA, PTFE, PETG, polycarbonate, polypropylene, polyethylene, polyamide, polyvinyl chloride, glass-fiber polypropylene (GFPP), and nylon. For example, in some embodiments, holder 100 comprises one or more materials suitable for use in a laboratory setting or laboratory experimentation. For example, but without limitation, in some embodiments holder 100 may comprise any one of a glass, plastic, resin, silicon, and other non-conductive materials. In some embodiments, holder 100 comprises a buoyant material. In some embodiments, holder 100 comprises a non-buoyant material. In some embodiments, holder 100 comprises a 3D printed material. In some embodiments, holder 100 comprises a sterilizable and/or autoclavable material. In some embodiments, holder 100 comprises any of PLA, PEEK, ABS, PET, PVA, PTFE, PETG, polycarbonate, polypropylene, polyethylene, polyamide, polyvinyl chloride, nylon, glass-fiber polypropylene (GFPP), and the like. In some embodiments, device 100 comprises a material that is biocompatible, hydrophobic and/or thermoresistant. In some embodiments, device 100 comprises at least one coating, wherein the coating may be a biocompatible coating, a hydrophobic coating, a thermoresistant coating, and other coatings as would be known by one of ordinary level of skill in the art.

It should be appreciated that any fluids at any concentration and flow rates may be provided to at least a portion of holder 100 (e.g., air stone 240). For example, fluids comprising air, oxygen, carbon dioxide, nitrogen, air mixtures, gas mixtures, or any combination thereof may be fluidly supplied to at least a portion of holder 100 (for example, dispersed through air stone 240). In a preferred example, carbogenation or carbonating fluids are introduced into holder 100. Exemplary flow rates may be between 0.1 mL/hour to 10 L/min, and any flow rate in between, such as 1 L/min. Although exemplary fluids, concentrations and flow rates are provided, it should be appreciated that any fluids, concentrations and flow rates known by one of ordinary level of skill in the art may be supplied to holder 100, for example, fluids, concentrations and flow rates known to provide appropriate carbogenation to tissue or cells (e.g., brain slices).

In some embodiments, holder 100 further comprises one or more sensors positioned within or on the holder. Exemplary sensors include, but are not limited to, temperature sensors, pressure sensors, flow sensors, light sensors, sound sensors, liquid sensors, optical sensors, proximity sensors, IMU, or any combination thereof.

### Methods of Use

Aspects of the present invention relate to exemplary methods of use for a specimen holder of the present invention. In some embodiments, any specimen holder of the present invention (e.g., specimen holder 100) is used for holding specimens within the holder and applying heat, cooling and/or fluid to the samples. In some embodiments, the specimens or samples are slices of brain tissue. In some embodiments, at least one fluid is applied to specimen holder 100. In some embodiments, at least one fluid, liquid, or medium is placed in liquid tray 150 of specimen holder 100 and the specimen are partially or wholly submerged in the fluid medium. In some embodiments, brain tissue undergoes carbogenation in specimen holder 100, In some embodiments, brain tissue undergoes an application of heat and/or carbogenation in specimen holder 100. In some embodiments, specimen holder 100 is at least partially submerged in a water bath (e.g., water bath 400). In some embodiments, specimen holder 100 is connected to at least one fluid source and/or at least one thermal or temperature controlling means (e.g., a heat source). In some embodiments, specimen holder 100 is placed in a cooling bath. In some embodiments, specimen holder 100 is used for electrophysiology of the samples. In some embodiments, specimen holder 100 is used to incubate samples, or perfuse samples.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention.

What is claimed is:

1. A specimen holder comprising:
a base having a lower surface and a plurality of walls extending upward from the lower surface, defining a cavity;
a tray support platform connected to the plurality of walls and arranged parallel to the lower surface of the base;
a liquid tray comprising a bottom and a plurality of walls extending upwards from the bottom, forming a cavity in the liquid tray;
a specimen tray comprising a frame with a bottom portion and a top portion and one or more openings passing through the specimen tray;
the specimen tray is configured to reside within the liquid tray; and
the liquid tray is placed on the tray support platform of the base.

2. The specimen holder of claim 1, further comprising a layer of material disposed between the bottom and top portion of the specimen tray and forming one or more sample wells in the openings of the specimen tray.

3. The specimen holder of claim 2, wherein the layer of material is at least one of a mesh material, a porous material, a permeable material, a grid material, a metal material, a plastic material, or a nylon material.

4. The specimen holder of claim 1, wherein the base further comprises one or more openings in the plurality of walls of the base configured to allow fluid to pass through from the exterior of the base into the cavity of the base.

5. The specimen holder of claim 1, wherein the base further comprises one or more holes in the lower surface of the base configured to allow fluid to pass through from the exterior of the base into the cavity of the base.

6. The specimen holder of claim 1, wherein the base further comprises one or more legs extending downward from the base.

7. The specimen holder of claim 1, further comprising at least one weight positioned within the cavity of the base.

8. The specimen holder of claim 1, wherein the openings in the specimen tray comprise a shared opening with one or more tubes positioned in the shared opening.

9. The specimen holder of claim 8, further comprising an air stone positioned in the cavity of the liquid tray and fluidly connected to the one or more tubes.

10. The specimen holder of claim 9, wherein the shared opening is positioned centrally in the specimen tray, and extends upward a height from the tray.

11. The specimen holder of claim 1, wherein the base comprises a peripheral ridge extending upwards from the tray support platform.

12. The specimen holder of claim 1, wherein the base comprises one or more corner posts extending upwards from at least one corner of the tray support platform.

13. The specimen holder of claim 1, wherein the specimen tray further comprises one or more legs extending downward from the bottom portion of the frame.

14. The specimen holder of claim 1, wherein the specimen tray comprises one or more clips to mechanically and removably affix the top portion onto the bottom portion.

15. The specimen holder of claim 1, wherein the specimen holder comprises at least one material selected from the group consisting of: PLA, PEEK, ABS, PET, PVA, PTFE, PETG, polycarbonate, polypropylene, polyethylene, polyamide, polyvinyl chloride, glass-fiber polypropylene (GFPP), and nylon.

16. The specimen holder of claim 1, wherein the base has a length ranging between 5 cm and 20 cm, a width ranging between 5 cm and 20 cm, and a height ranging between 5 cm and 15 cm.

17. The specimen holder of claim 1, wherein the specimen tray has a length ranging between 5 cm and 15 cm, a width ranging between 5 cm and 15 cm, and a height ranging between 1 cm and 10 cm.

18. The specimen holder of claim 1, wherein the liquid tray has a length ranging between 5 cm and 15 cm, a width ranging between 5 cm and 15 cm, and a height ranging between 1 cm and 10 cm.

19. The specimen holder of claim 1, wherein the base is a shape selected from the group consisting of: a triangle, a square, a rectangle, a trapezoid, a pentagon, a hexagon, an octagon, a decagon, a circle.

20. The specimen holder of claim 1, wherein the specimen holder is positioned in a water bath and the water of the bath does not intrude into the cavity of the liquid tray.
